(19) United States
(12) Patent Application Publication
(10) Pub. No.: US 2026/0251870 A1
(43) Pub. Date: Aug. 27, 2026

(54) THERMAL ISOLATION OF LASER TUNING SECTIONS

(71) Applicant: Lumentum Operations LLC, San Jose, CA (US)

(72) Inventors: Colin SMITH, Paignton (GB); Michael C. LARSON, Oakland, CA (US)

(21) Appl. No.: 19/232,091

(22) Filed: Jun. 9, 2025

Related U.S. Application Data
(60) Provisional application No. 63/761,439, filed on Feb. 21, 2025.

(51) Int. Cl. G02B 6/42

(52) U.S. Cl. CPC G02B 6/4273; G02B 6/4245; G02B 6/4267

(57) ABSTRACT

In some implementations, a photonic structure may include a substrate, an optical waveguide, a heating component attached to a region of the optical waveguide, and a thermal insulation material positioned between the substrate and the region of the optical waveguide. Additionally, the heating component may be configured to apply heat to the region of the optical waveguide, and the thermal insulation material may be configured to thermally insulate the substrate from the heat applied to the region of the optical waveguide.

### CROSS-REFERENCE TO RELATED APPLICATION

This Patent Application claims priority to U.S. Patent Application No. 63/761,439, filed on Feb. 21, 2025, and entitled “THERMAL ISOLATION OF LASER TUNING SECTIONS.” The disclosure of the prior Application is considered part of and is incorporated by reference into this Patent Application.

### TECHNICAL FIELD

The present disclosure relates generally to tunable sections and to thermal isolation of laser tuning sections.

### BACKGROUND

A tunable laser is a laser for which an optical frequency of operation can be altered in a controlled manner. A tunable laser may be used in an optical communications system, a telecommunication system, and/or the like, such as in a transceiver, a line card, and/or the like. A tunable laser may include a mirror that is made optical frequency selective, and a reflection optical frequency of the mirror is tuned. In some cases, a waveguide grating may be used as an optical frequency selective mirror in a tunable laser. In a waveguide grating, periodic perturbations of the effective refractive index of the waveguide are created to selectively reflect light at an optical frequency corresponding to the spatial frequency of the periodic refractive index perturbations. A waveguide grating can be tuned by thermal tuning (e.g., heating). Thermal tuning uses considerable amounts of heat applied to the waveguide grating to change the temperature of the waveguide grating.

### SUMMARY

In some implementations, a photonic structure includes a substrate; an optical waveguide; a heating component attached to a region of the optical waveguide; and a thermal insulation material positioned between the substrate and the region of the optical waveguide, wherein the heating component is configured to apply heat to the region of the optical waveguide, and the thermal insulation material is configured to thermally insulate the substrate from the heat applied to the region of the optical waveguide.

In some implementations, a photonic structure includes a substrate; an optical waveguide; a set of heating components respectively attached to a set of regions of the optical waveguide; and at least one thermal insulation material layer positioned between the substrate and the set of regions of the optical waveguide, wherein the set of heating components are respectively configured to apply heat to the set of regions of the optical waveguide, and the at least one thermal insulation material is configured to thermally insulate the substrate from the heat applied to the set of regions of the optical waveguide.

In some implementations, a photonic structure includes a substrate; first and second support bars extending upwardly from the substrate; an optical waveguide that is supported by the first and second support bars so that a first gap exists between the substrate and the optical waveguide; a heating component attached to a region of the optical waveguide; and a thermal insulation material the fills the first gap, wherein the heating component is configured to apply heat to the region of the optical waveguide, and the thermal insulation material is configured to thermally insulate the substrate from the heat applied to the region of the optical waveguide.

In some implementations, a tunable laser includes a thermally-controlled structure, comprising a light source that generates light; an optical waveguide region above a substrate, wherein the optical waveguide region includes a grating for reflecting the light generated by the light source; a heating component attached to the optical waveguide region, wherein the heating component and the optical waveguide region form a tuning section of the tunable laser; and a thermal insulation material positioned between the substrate and the optical waveguide region, wherein the thermal insulation material insulates the substrate from heat generated by the tuning section.

### BRIEF DESCRIPTION OF THE DRAWINGS

FIG. 1 shows a top view of a tunable laser structure that includes multiple tuning sections.

FIG. 2 shows a cross-section of a tunable photonic structure according to one or more implementations.

FIG. 3 shows a cross-section of a tunable photonic structure according to one or more implementations.

FIGS. 4A through 4D show cross-section views taken along portions of a tunable photonic structure that includes multiple support bars according to one or more implementations.

FIGS. 5A and 5B show three dimensional views (3D) of tunable photonic structures according to one or more implementations.

FIG. 6A is a 3D view of a thermal finite element analysis (FEA) simulation for a tunable photonic structure that includes a thermal insultation material according to one or more implementations.

FIG. 6B is a cross-section view of the thermal FEA simulation for the tunable photonic structure shown in FIG. 6A according to one or more implementations.

FIG. 6C is a 3D view of a thermal FEA simulation for a tunable photonic structure that does not include a thermal insultation material.

FIG. 6D is a cross-section view of the thermal FEA simulation for the tunable photonic structure 600b shown in FIG. 6C.

### DETAILED DESCRIPTION

The following detailed description of example implementations refers to the accompanying drawings. The same reference numbers in different drawings may identify the same or similar elements.

A tunable laser is a laser for which an optical frequency of operation can be altered in a controlled manner. A tunable laser may be used in an optical communications system, a telecommunication system, or the like, such as in a transceiver, a line card, or the like. A tunable laser may include a include a tuning mechanism that changes the optical path length between mirrors included in the tunable laser. For instance, the tunable laser may operate as or in similar manner to a Fabry-Perot filter, which includes two parallel mirrors creating a resonant cavity. The tuning mechanism adjusts the optical path length between these mirrors, thereby changing the resonant frequency and tuning the laser to different optical frequencies. The tunable laser may be tuned by thermal tuning (e.g., heating). Applying heat to a laser structure of the tunable laser causes thermal expansion of the materials, which increases or decrease the physical distance between the mirrors. Additionally, heat can alter the refractive index of the materials within the cavity, further changing the optical path length. These combined effects enable tuning of the output optical frequency.

As described above, the optical frequency tuning of a laser may be achieved by altering the path length of a part or all of the waveguide. Altering the path length can be accomplished by either a physical dimension change or through a change in a refractive index of the waveguide. For example, changing the refractive index of the waveguide can be done by current injection into laser cavity material or changing the temperature applied to the laser cavity material. A larger frequency tuning of the laser may be achieved by applying temperature independently to one or more tuning sections, which may be temperature controlled. For example, a tuning section of a laser may be a dedicated region within a cavity of the laser that allows for optical frequency tuning by modifying the refractive index of a portion of the waveguide. In some examples, a tuning section may include a heating component such as a micro-heater or a resistive heating element near the waveguide. If an electric current is applied to the heating component, then Joule heating may raise the temperature of the waveguide material, leading to a thermal-induced refractive index shift. In some examples, a tuning section may be thermally isolated from one or more other tuning sections and/or a substrate of the laser to reduce overheating neighboring elements of the laser.

In some cases, a tunable laser may include a suspended structure that may thermally isolate the one or more tuning sections. For example, the waveguide of the tunable laser may be suspended over a substrate by a set of bridges. This provides thermal isolation, increases thermal impedance, and reduces thermal mass. As a result, the tunable laser may achieve higher tuning efficiency and consume less power. The set of bridges may be thermally conductive, and therefore may provide pathways for heat to escape the suspended structure. Thus, a temperature of the suspended structure may be lower near the bridges. This may affect a uniformity of the heating of the mirror, particularly if a continuous grating is used, and may cause laser tuning distortion.

Some implementations described herein provide thermally-controlled (e.g., thermally-tuned) photonic structures. For example, a tunable photonic structure may include one or more heating components, a waveguide, one or more portions of a thermal isolation material, and a substrate. In some examples, a heating component may be used to heat a portion of the waveguide (e.g., a tuning section of the waveguide). Additionally, there may be a thermal isolation material that is below the tuning section of the waveguide and above the substrate such that the tuning section is thermally isolated from the substrate. In some examples, the thermal isolation material may be a synthetic solid material with a coefficient of thermal expansion (CTE) that satisfies or is below a configured CTE threshold. For instance, the thermal isolation material may be a porous material, such as an aerogel material. An aerogel (e.g., silica aerogel) may have a CTE that is comparable to the substrate or waveguide of the photonic and may be used as a solid structure as the thermal isolation material. In this way, by including a thermal isolation material that may be fixed in place and have a constant CTE in the tunable photonic structure, fluctuations in heat that could damage components that neighbor a tuning structure are reduced. Additionally, the thermal isolation material may serve as a solid supporting structure, which may be less prone to stress, deformation, and/or cracking and improve reliability compared to the suspended structure described elsewhere herein. Additionally, the multiple sections of the thermal isolation material may be respectively applied to multiple tuning sections of the waveguide, enabling thermal isolation between the multiple tuning sections and the substrate, which may increase tuning efficiency of the waveguide.

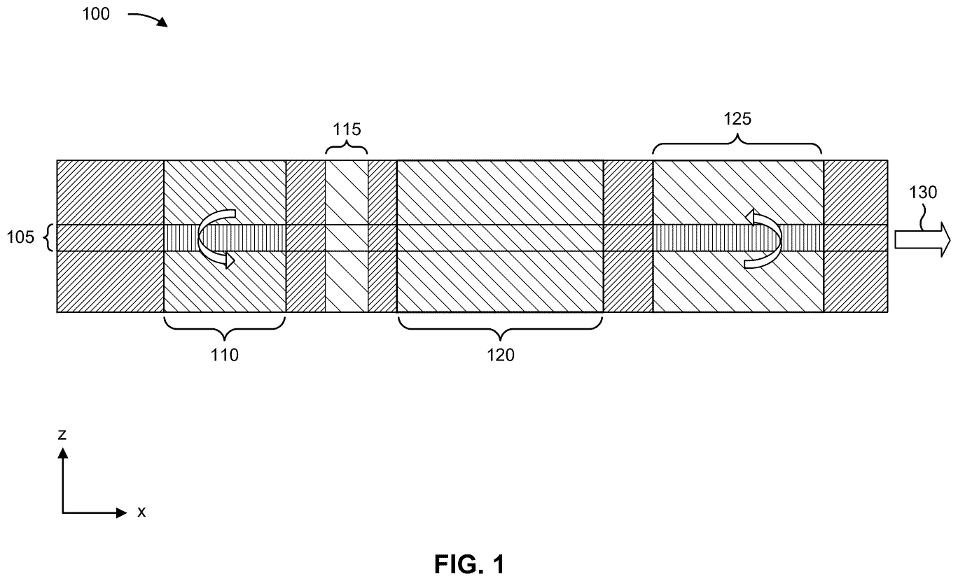

FIG. 1 shows a top view of a tunable laser structure 100 that includes multiple tuning sections. The tunable laser structure 100 includes an optical waveguide 105, a rear tuning section 110 (e.g., a mirror), a phase tuning section 115, a gain section 120, and a front tuning section 125 (e.g., a mirror). As shown in FIG. 1, the optical waveguide 105 spans across the multiple tuning sections of the tunable laser structure 100, such that multiple sections of the optical waveguide 105 respectively correspond to the multiple tuning sections.

The optical waveguide 105 may be an optical structure designed to guide light waves along a predetermined path with minimal loss of energy. The optical waveguide 105 may include a core material with a first refractive index, surrounded by a cladding with a second refractive index that is lower than the first refractive index, which helps to confine the light within the core due to the boundary conditions created by a change in index. In the context of the tunable laser structure 100, the optical waveguide 105 directs the light generated by the tunable laser structure 100 to enable a laser output 130. This control over the light path and optical frequency enables the tunable laser structure 100 to be used in environments that leverage variable laser outputs (such as in telecommunications, spectroscopy, and/or medical diagnostics, among other examples). The design and material composition of the optical waveguide 105 are factors that influence the efficiency, stability, and tunability of the tunable laser structure 100.

The rear tuning section 110 may be segment at the end of the laser cavity where adjustments can be made to control the output optical frequency. Applying heat to the rear tuning section 110 causes the materials to expand and can alter the refractive index, both of which change the optical path length. The optical path length may be the effective distance light travels within the laser cavity, considering both the physical length and the refractive index of the medium. By modifying the optical path length, the resonant frequency of the cavity shifts, allowing for tuning of the output optical frequency. In some examples, the rear tuning section 110 may use a distributed Bragg reflector (DBR) or other reflective elements, and the tuning may be achieved by thermally or electrically modifying the refractive index of the optical waveguide 105, thereby shifting a resonant frequency of the laser cavity thereby setting the operating frequency of the tunable laser structure 100.

The phase tuning section 115 may be used for fine-tuning the optical phase within the laser cavity of the tunable laser structure 100. In some examples, the phase tuning section 115 may tune the optical frequency similar to the rear tuning section 110, but may not include mirror gratings. Accordingly, the phase tuning section 115 may change the refractive index, thereby changing the optical path length within the phase tuning section 115 which results in change to the optical output frequency.

The gain section 120 may serve as an amplification region of the tunable laser structure 100, where electrical current may be injected to generate optical gain through stimulated emission. The gain section 120 may include an active gain medium (e.g., made of semiconductor materials such as indium phosphide). The level of gain can be adjusted to enhance the output power, improve spectral purity, or enable dynamic tuning of the laser while maintaining stable operation. The gain section 120 works in conjunction with the tuning sections to select and amplify the desired optical frequency output of the tunable laser structure 100.

The front tuning section 125 may be similar to the rear tuning section 110, but may be a segment at the front for the laser cavity where adjustments can be made to control the output optical frequency. Similar to the rear tuning section 110, the front tuning section 125 can include a DBR or another reflective component, with tuning achieved by altering the refractive index of the optical waveguide 105 through electrical or thermal means.

The rear tuning section 110, phase tuning section 115, and front tuning section 125 may help define a linewidth, an output power, and/or an optical frequency stability of the tunable laser structure 100, ensuring efficient coupling of light into an external optical system. As shown in FIG. 1, the tunable laser structure 100 includes three tuning sections; however, in other examples, the tunable laser structure 100 may include any number of tuning sections.

As indicated above, FIG. 1 is provided as an example. Other examples may differ from what is shown in and described with regard to FIG. 1. For example, the techniques described herein may be implemented in various photonic structures, such as a Fabry-Perot laser structure or a distributed feedback laser structure, among other examples. Such photonic structures may include a tuning section that spans or encompasses the full length of the optical waveguide 105.

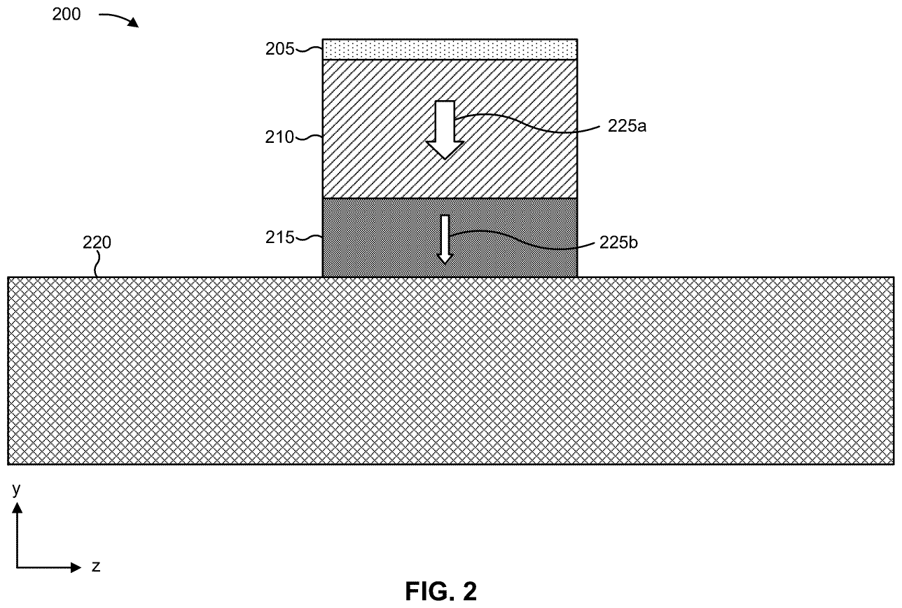

FIG. 2 shows a cross-section of a tunable photonic structure 200 according to one or more implementations. In some examples, the tunable photonic structure 200 may include or implement one or more aspects and/or components of the tunable laser structure 100. As shown in FIG. 2, the tunable photonic structure 200 may include a heating component 205, a waveguide section 210, a thermal insulation material 215, and a substrate 220. In some examples, the waveguide section 210 may be a section or region of the optical waveguide 105.

In some implementations, the tunable photonic structure 200 may be an optical interferometer (e.g., Mach-Zehnder (MZ) interferometer). For instance, the tunable photonic structure 200 may include comprising two or more optical waveguides (e.g., optical waveguides 105) in which one or more of the waveguides incorporates a heating and/or insulation element (e.g., the heating component 205) to adjust the optical path length in one or both of the optical waveguides resulting in a relative change in the optical phase between the two waveguide outputs,. For example, the heating and/or insulation element may be configured to change the phase of an optical interferometer to set for a set of modulation conditions. The set of modulation conditions may depend on a modulation format for the MZ interferometer to output according to a sinusoidal response with change in the optical phase. In some examples, the modulation format may be in-off-keying (OOK). For instance, OOK may be modulation format used in digital systems where the MZ interferometer may be set to a quadrature condition with a midway between a peak and null output condition. For other systems types, such as coherent systems, may use modulation format of quadrature phase-shift keying (QPSK), where the output of the MZ interferometer may be set to a null condition.

In some implementations the tunable photonic structure 200 may be an example of or implement in part one or more photonic integrated circuits (PICs). For example, PICs may be optical devices that integrate multiple photonic functions on a single optical chip. Transmitter PICs may generate and modulate optical signals for transmission and receiver PICs may detect and process incoming optical signals, enabling high-speed data communication in applications such as fiber-optic networks and data centers.

In some examples, the heating component 205 may be positioned above (e.g., deposited on) the waveguide section 210. The heating component 205 may be a resistive heater, a microheater, a Peltier element, and/or an integrated waveguide heaters. That is, the heating component 205 may be a resister (or other component) that generates heat when a current is applied. The heating component 205 may be a thin-film electrode. The heating component 205 may include a metal or a metal alloy, such as tantalum nitride (TaN). In some other examples, the heating component 205 may be positioned below the waveguide section 210 (e.g., deposited on the substrate 220). In some examples, the combination of the heating component 205 and the waveguide section 210 may be an example of a tuning section described elsewhere herein (e.g., the rear tuning section 110, the phase tuning section 115, and/or the front tuning section 125). For instance, the region of the optical waveguide attached to the heating component (e.g., the waveguide section 210) forms an optical tuning section of the optical waveguide. In some implementations, the heating component 205 may span the width of the waveguide section 210 or span a portion of the width of the waveguide section 210.

In some implementations, the waveguide section 210 may include a waveguide core having a higher refractive index, which is sandwiched between upper and lower cladding layers with lower refractive indices. Additionally, the waveguide core itself may be laterally patterned to have a width narrower than the overall width of the waveguide section 210. In such configurations, the heating component 205 may be positioned not only above or below the waveguide section 210, but also laterally to each side of the waveguide core. This allows for flexible positioning of the heating component 205 relative to the waveguide core cladding layers of the waveguide section 210, and may enable more efficient or targeted thermal tuning of the optical properties of the waveguide section 210.

The thermal insulation material 215 may be positioned above (e.g., deposited on) the substrate 220. In some examples, the thermal insulation material 215 may have a porosity ratio or void ratio that satisfies (e.g., equals or exceeds) a threshold, such that the density and the thermal conductivity value are lower compared to a standard unmodified material structure. For instance, a silica aerogel may have a density that is approximately 1/800^{th} and a thermal conductivity value that is approximately 1/40^{th} that of a standard silica crystalline material. In some examples, the thermal conductivity value of the thermal insulation material 215 may be less than or equal to 0.1 watts per meter-Kelvin (W/m·K). In some examples, the thickness of the thermal insulation material 215 may range from 1 micron to 40 microns. In some examples, the thickness selected for the thermal insulation material 215 may be based on the thermal conductivity value of the thermal insulation material 215 and an upper bound temperature output of the heating component 205 applied to the waveguide section. For example, the thermal insulation material 215 may have a thickness such that a combination of the thickness and thermal conductivity value of the thermal insulation material 215 can reduce or increase a temperature from an upper bound or lower bound temperature 225a of the heating component 205 to a temperature 225b that satisfies (e.g., is less than or equal to) a temperature threshold. In some examples, the temperature threshold may be based on a material structure of the substrate 220 and/or a working temperature range of components that neighbour the waveguide section 210. In some examples, the thermal insulation material 215 may be an aerogel. For example, the thermal insulation material 215 may be a silica aerogel, a carbon aerogel, a graphene aerogel, a metal oxide aerogel (e.g., made from materials such as titanium dioxide (TiO₂), aluminum oxide (Al₂O₃), or iron oxide), an organic polymer aerogel, and/or a chalcogenide aerogel (e.g., made from elements like selenium or tellurium), among other examples. In some other examples, the thermal insulation material 215 may be any solid material that has a thermal conductivity value that is less than or equal to 0.1 W/m·K. In some examples, the thermal insulation material 215 may contain gas particles (e.g., air, nitrogen gas, carbon dioxide, xenon, krypton, and/or argon, among other example) where the thermal conductivity value of the thermal insulation material 215 may be lower than the thermal conductivity value of the gas particles based on the mean free path of the gas within voids of the thermal insulation material 215 (e.g., the Knudsen effect). In some examples, the thermal insulation material 215 comprises a structure that includes voids comprising more than half of a volume of the thermal insulation material 215, where the voids may be filed with an inert gas or may be a vacuum. In some examples, the voids included in the thermal insulation material 215 may reduce the material density by at least a factor of two. For example, the density of silica is approximately 2.65 grams per cubic centimeter (g/cm³) and the density of silica aerogel is less than 1.32 g/cm³ (e.g., ranging from 0.0011 g/cm³ to 0.5 g/cm³). Additionally or alternatively, the voids included in the thermal insulation material 215 may reduce the thermal conductivity value by at least a factor of two. For example, the thermal conductivity value of silica is approximately 1.4 W/m·K and the thermal conductivity value of silica aerogel is less than or equal to 0.1 W/m·K (e.g., ranging from 0.003 W/m·K to 0.013 W/m·K).

The substrate 220 may include a semiconductor material. For example, the semiconductor material may be indium phosphide (InP), gallium arsenide (GaAs), Indium Gallium Arsenide (InGaAs), silicon (Si), sapphire (Al₂O₃), and/or lithium niobate (LiNbO₃), among other examples.

As indicated above, FIG. 2 is provided as an example. Other examples may differ from what is shown in and described with regard to FIG. 2.

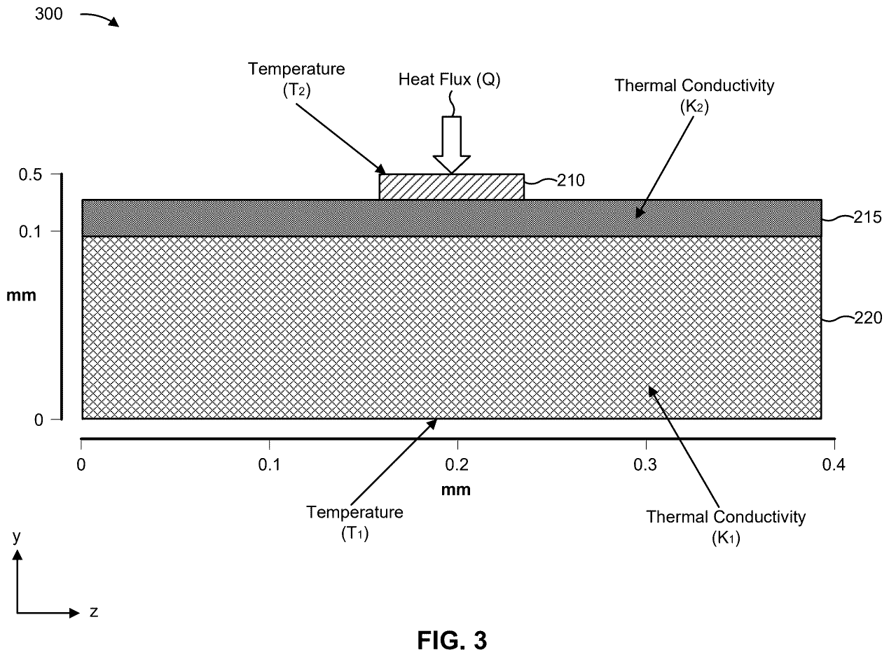

FIG. 3 shows a cross-section of a tunable photonic structure 300 according to one or more implementations. In some examples, the tunable photonic structure 300 may include or may implement one or more aspects of the tunable laser structure 100 and/or the tunable photonic structure 200. As shown in FIG. 3, the tunable photonic structure 300 may include the waveguide section 210, the thermal insulation material 215, and the substrate 220 as described elsewhere herein.

As shown in FIG. 3, the substrate may have a width of approximately 0.4 millimeter (mm) and the thickness of 0.1 mm, the thermal insulation material 215 may have a width of approximately 0.4 mm and the thickness of 0.3 mm, and the waveguide section 210 may have a width of approximately 0.1 mm and the thickness of 0.1 mm. In some other implementations, however, the waveguide section 210, the thermal insulation material 215, and the substrate 220 may have any width and thickness. In some implementations the thermal insulation material 215 may have the same width as the substrate 220. In some implementations the thermal insulation material 215 may have the same width as the waveguide section 210.

As shown in FIG. 3, a heat flux (Q) may be applied to the waveguide section 210, such that the waveguide section 210 is at a temperature of T₂. The thermal insulation material 215 may have a thermal conductivity value of K₂. If the thermal insulation material 215 is silica, then the value of K₂ may be 1.3 W/m·K and if the thermal insulation material 215 is silica aerogel, then the value of K₂ may be less than 0.03 W/m·K (e.g., ranging from 0.013 W/m·K to 0.003). The substrate 220 has a thermal conductivity value of K₁, where K₁ may be greater than K₂. The substrate 220 has a temperature of T₁ that is less than T₂ based on the thermal insulation material 215 reducing the exchange of heat from the waveguide section 210 to the substrate 220. In some implementations, the temperature of T₁ may satisfy (e.g., may be less than or equal to) a temperature threshold that is based on an operating temperature range of the substrate 220.

In some examples, the tunable photonic structure 300 may include an interface material between the waveguide section 210 and the thermal insulation material 215 and between the thermal insulation material 215 and the substrate 220. The interface material may enable crystal lattice matching between the substrate 220 and thermal insulation material 215. For example, crystal lattice matching is a semiconductor fabrication and epitaxial growth technique, where the atomic arrangement of a material being deposited (epitaxial layer) is aligned with the atomic structure of the underlying substrate 220. This alignment ensures minimal lattice strain, reduces dislocations, and improves electrical and optical properties of the resulting material. In other words, the interface material may include a first layer that is between the substrate 220 and the thermal insulation material 215, where the first layer is associated with a first lattice matching with the substrate 220, and a second layer that is between the waveguide section 210 and the thermal insulation material 215, where the second layer may associated with a second lattice matching with the waveguide section 210. In some examples, the interface material may be a non-porous material that encloses the thermal insulation material 215. For instance, if the thermal insulation material 215 is silica aerogel, then the interface material may be non-porous silica, to block air from entering or leaving the silica aerogel.

In some implementations, the thermal insulation material 215 may be grown above the substrate 220 (with or without an intervening interface material) via techniques of epitaxial growth. For instance, epitaxial growth of the thermal insulation material 215 may include a process in which a layer is grown on the substrate 220 in such a way that the grown layer mimics the crystallographic orientation and structure of the substrate 220. Epitaxial growth can be achieved through various methods, such as molecular beam epitaxy (MBE), chemical vapor deposition (CVD), and/or liquid phase epitaxy (LPE), among other examples.

In some implementations, the thermal insulation material 215 may have a CTE associated with a percentage change in CTE over an operating temperature range of the heating component 205, where the percentage change satisfies a percentage change threshold. For instance, the percentage change threshold may be 30%, or some other percentage value between 0% and 100%. For reference, silica and/or silica aerogel changes from a CTE of approximately 5.1E−7 at 20 degrees Celsius (° C.) to approximately 5.8E−7 at 300° C. (~14%).

The thermal insulation material 215 of the tunable photonic structure 300 may enable efficient laser thermal tuning without an air gap separating the waveguide section 210 and the substrate 220. In some examples, the thermal insulation material 215 may be associated with a high thermal efficiency such that the thermal insulation material 215 has a reduced power input to achieve a given temperature differential compared to implementation of an air gap, which may improve power dissipation and increase the tuning range for tuning at the waveguide section 210. Additionally, or alternatively, the thermal insulation material 215 may be less sensitive to changes in the surrounding atmosphere compared with the air gap implementation, which may be highly dependent on the surrounding gas, enabling thermal insulation consistency across various atmosphere compositions. Additionally, or alternatively, the efficiency of the thermal insulation material 215 may be varied based on changing the thickness and composition of the thermal insulation material 215 (e.g., the porosity) enabling the thermal insulation material 215 to thermally insulate across a dynamic range of temperatures. Additionally, or alternatively, the thermal insulation material 215 may enable electrical isolation, which may reduce a conductive path to the substrate 220 and reduce electrical noise and therefore reduce phase noise in the laser. Additionally, or alternatively, implementation of a thermal insulation material 215 may be simpler and more mechanically stable compared to air bridges that insulates the waveguide from the substrate 220 via an air gap.

As indicated above, FIG. 3 is provided as an example. Other examples may differ from what is shown in and described with regard to FIG. 3.

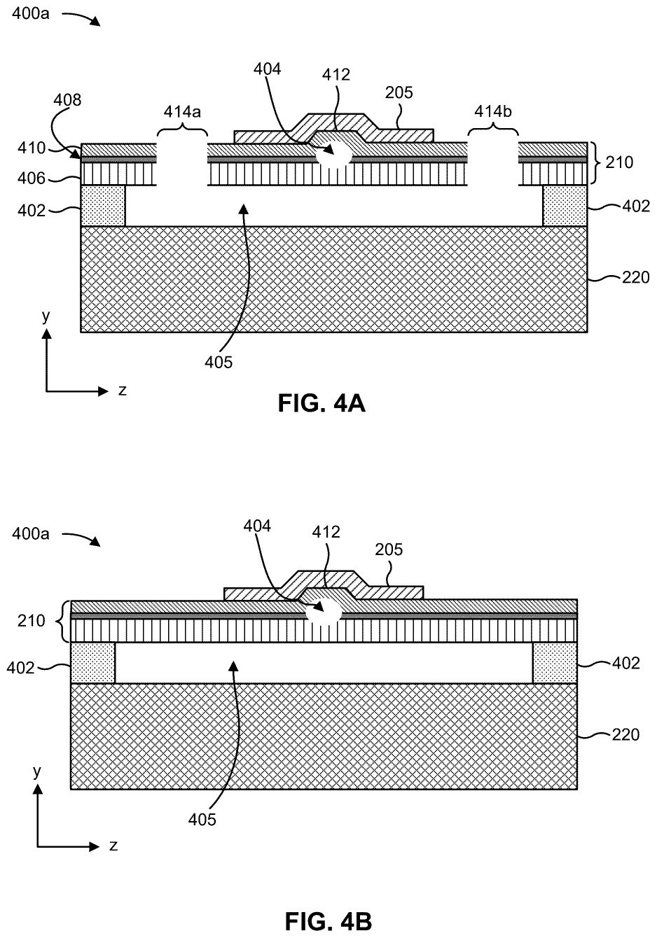

FIGS. 4A through 4D show cross-section views taken along portions of a tunable photonic structure 400 that includes multiple support bars according to one or more implementations. In some examples, the tunable photonic structure 400 may include or may implement one or more aspects of the tunable laser structure 100, the tunable photonic structure 200, and/or the tunable photonic structure 300. As shown in FIGS. 4A through 4D, the tunable photonic structure 400 includes the heating component 205, the waveguide section 210, and the substrate 220 as described elsewhere herein. Additionally, FIGS. 4A and 4B show a tunable photonic structure 400a with a gap 405 prior to filling the gap 405 while FIGS. 4C and 4D show a tunable photonic structure 400b where the gap 405 is filled with the thermal insulation material 215.

In some implementations for FIGS. 4A through 4D, the waveguide section 210 may be a section of an optical waveguide structure (e.g., the optical waveguide 105) having a common top ridge 412 for guiding a light mode 404. The tunable photonic structure 400 includes first and second support bars 402 (spaced apart, on either side of the substrate 220) extending upwardly from the substrate 220. The waveguide section 210 is supported by the first and second support bars 402 above the substrate 220, forming a gap 405 between the substrate 220 and the waveguide section 210. In some examples, the first and second support bars 402 may comprise layers of indium gallium arsenide phosphide (InGaAsP) in addition to InP.

The waveguide section 210 may include a stack of a bottom cladding layer 406 supported by the first and second support bars 402, a core layer 408 disposed on the bottom cladding layer 406, and a top cladding layer 410 disposed on the core layer 408. The top cladding layer 410 has the ridge 412 on top, for guiding the light mode 404 along the ridge 412. In some examples, the first and second support bars 402 may span the total length of the optical waveguide (e.g., the total length of the optical waveguide 105). In some implementations, the first and second support bars 402 may only span the length of the waveguide section 210. In such implementation, if the tunable photonic structure 400 includes multiple waveguide sections 210, that respectively correspond to multiple tuning sections, each of the multiple waveguide sections 210 may have respective first and second support bars 402.

The refractive index of the core layer 408 is higher than refractive indices of the top cladding layer 410 and the bottom cladding layer 406, for confining the light mode 404 guided by the ridge 412 substantially to the core layer 408. The effective refractive index of the waveguide section 210 is spatially modulated, forming a grating for reflecting the light mode 404 guided by the waveguide section 210 to propagate back therein. For example, the refractive index of the core layer 408 can be spatially modulated, or the ridge 412 can be laterally corrugated to create the spatial modulation of the effective refractive index. At least one of phase or amplitude of the spatial modulation of the effective refractive index is varying along the optical axis, forming modulation crests and valleys across the optical waveguide. The heating component 205 may disposed on an insulating dielectric layer, not shown, which may be deposited on the top cladding layer 410.

In operation, the guided light mode 404 propagates along the ridge 412. An optical frequency component of the guided light mode 404 is reflected to propagate back along the ridge 412, thus providing an optical feedback to the laser. The reflected optical frequency component has an optical frequency corresponding to the spatial frequency of the effective refractive index modulation of the waveguide section 210. The heating component 205 provides heating to the waveguide section 210, for tuning the optical frequency of the reflected optical frequency component. When heat is applied by the heating component 205 to the waveguide section 210, spatial refractive index variations, caused by spatial temperature variations along the ridge 412 due to heat flow to the first and second support bars 402, are spatially coordinated with the modulation crests of the light mode 404. As a result, the heating by the heating component 205 substantially does not disturb or modify the reflected frequency spectrum beyond simply tuning of the center frequency of the reflected frequency spectrum. This allows one to reduce a bandwidth variation as the waveguide section 210 is tuned in optical frequency.

As shown in FIG. 4A through 4D, the waveguide section 210 has first and second arrays of openings 414a and 414b, respectively, extending through the waveguide section 210 and into the gap 405. The openings 414a and 414a run on opposite sides of the ridge 412, defining first and second arrays of heat conducting fingers, respectively, extending from the ridge 412 towards the first and second support bars 402. The openings 414a and 414b facilitate creation of a more uniform temperature distribution upon heating the tunable photonic structure 400a by the heating component 205. Both length and width of the openings 414a and 414b can be adjusted to improve the temperature uniformity.

As shown in FIGS. 4A and 4B, the gap 405 and the first and second arrays of openings 414a and 412b can be filled with the thermal insulation material 215. In some implementations, the gap 405 can be formed by lateral selective undercut etching of a sacrificial spacer layer. For example, the sacrificial spacer layer may be deposited on the substrate 220. Then the gap 405 can be formed by selective etching of the spacer layer through the first and second arrays of openings 414a and 414b, where the selective etching forms the first and second support bars 402. These etching techniques are generally referred to as “micromachining”, a term adopted from micro-electro-mechanical systems (MEMS) manufacturing. Accordingly, the first and second support bars 402 may serve as lithographically-defined bridges that connect the optical waveguide thermally to the substrate 220.

Additionally, as shown in FIGS. 4C and 4D, depositing the thermal insulation material 215 into the gap 405 prevents the infiltration of ambient air into the gap 405 to minimize the impact of humidity or other environment effects on thermal tuning properties. Such techniques of filling the gap 405 with the thermal insulation material 215 may be leveraged in non-hermetic applications. Additionally, the combination of the first and second support bars 402 thermal insulation material 215 may increase the mechanical strength of the tunable photonic structure 400.

In addition to the features described above, as illustrated in FIGS. 4C and 4D, the inclusion of the lateral bridges (i.e., the first and second support bars 402) provides benefits for the thermal and mechanical performance of the tunable photonic structure 400. Specifically, these lateral bridges offer an additional thermal shunt path from the waveguide section 210 to the substrate 220, which enables more precise tailoring of the temperature profile along the longitudinal axis of the optical waveguide. This improved control over the temperature distribution results in enhanced longitudinal temperature uniformity across the waveguide section 210, thereby supporting more stable and predictable optical tuning characteristics. Additionally, the lateral bridges serve this thermal management function in combination with the support bars 402 and the thermal insulation material 215 to contribute to the overall mechanical strength. Furthermore, the presence of the thermal insulation material 215 in the gap 405 acts to seal the vertical thermal path from the environment, minimizing the impact of humidity and other environmental factors on thermal tuning properties.

As indicated above, FIGS. 4A through 4D are provided as examples. Other examples may differ from what is shown in and described with regard to FIGS. 4A through 4D.

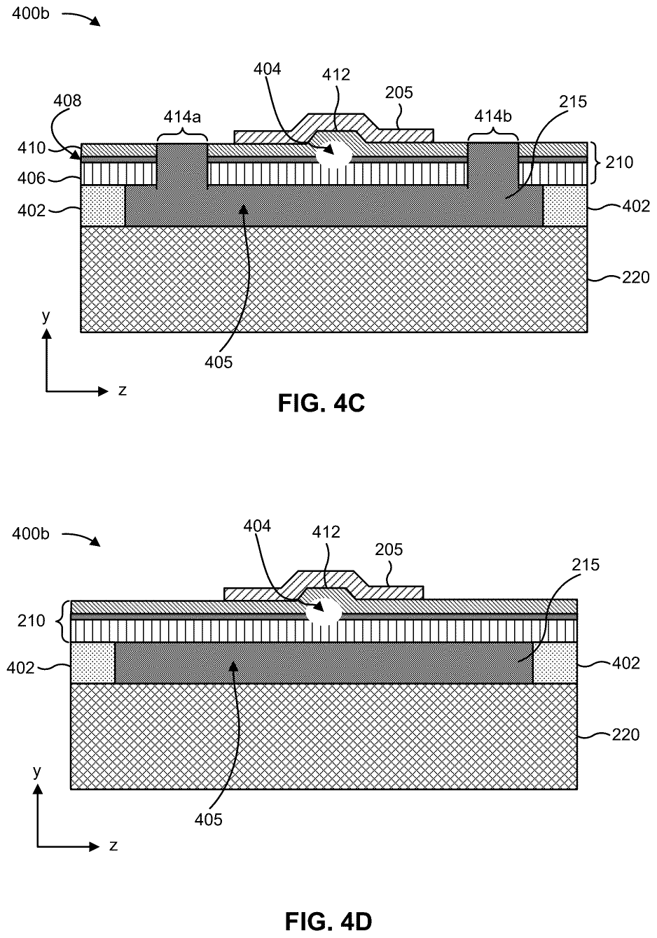

FIGS. 5A and 5B show a three dimensional (3D) views of a tunable photonic structures 500a and 500b according to one or more implementations. In some examples, the tunable photonic structures 500a and 500b may include or implement one or more aspects of the tunable laser structure 100, and/or the tunable photonic structures 200 through 400. For example, the tunable photonic structures 500a and 500b may include one or more portions of thermal insulation material 215 that is placed between one or more optical tuning sections 505 of an optical waveguide and the substrate 220. As described elsewhere herein, the optical tuning sections 505 may be the region of the optical waveguide (e.g., the waveguide section 210) attached to the heating component 205. In other words, the region of the optical waveguide attached to the heating component 205 forms the optical tuning section 505.

As shown in FIG. 5A, the tunable photonic structure 500a includes a single optical tuning section 505. In other implementations, the tunable photonic structure 500 could have two or more optical tuning section 505. As shown in FIG. 5A, the thermal insulation material 215 spans the width of the substrate 220 (e.g., in the z-direction) and spans the length of the optical tuning section 505 (e.g., in the x-direction). Accordingly, if the tunable photonic structure 500 included multiple optical tuning sections 505, then multiple respective portions of the thermal insulation material 215 may be placed in between the substrate 220 and a given optical tuning section 505 of the multiple optical tuning sections 505. In other words, a set of thermal insulation material layers respectively placed between the set of regions (e.g., set of optical tuning sections 505) and the substrate 220.

In other implementations, the thermal insulation material 215 may span the width of the substrate 220 (e.g., in the z-direction) and the length of the substrate 220 (e.g., in the x-direction). In other words, a single thermal insulation material layer that spans a length of the substrate 220 and is placed between the set of regions (e.g., set of optical tuning sections 505) and the substrate 220.

As shown in FIG. 5B, the tunable photonic structure 500b includes a multiple optical tuning sections 505 (e.g., optical tuning section 505a, 505b, and 505c). In some examples, the multiple optical tuning sections 505 may be examples of the rear-tuning section 110, the phase tuning section 115, and/or the front tuning section 125, as described with reference to FIG. 1. Additionally, as shown in FIG. 5B, the tunable photonic structure 500b multiple layers of the thermal insulation material 215 (e.g., thermal insulation material 215a, 215b, and 215c). The thermal insulation material 215a may be placed in between the substrate 220 and the optical tuning section 505a and may span the width of the substrate 220 (e.g., in the z-direction) and span the length of the optical tuning section 505a (e.g., in the x-direction). The thermal insulation material 215b may be placed in between the substrate 220 and the optical tuning section 505b and may span the width of the substrate 220 (e.g., in the z-direction) and span the length of the optical tuning section 505b (e.g., in the x-direction). The thermal insulation material 215c may be placed in between the substrate 220 and the optical tuning section 505c and may span the width of the substrate 220 (e.g., in the z-direction) and span the length of the optical tuning section 505c (e.g., in the x-direction).

As indicated above, FIGS. 5A and 5B is provided as examples. Other examples may differ from what is shown in and described with regard to FIGS. 5A and 5B.

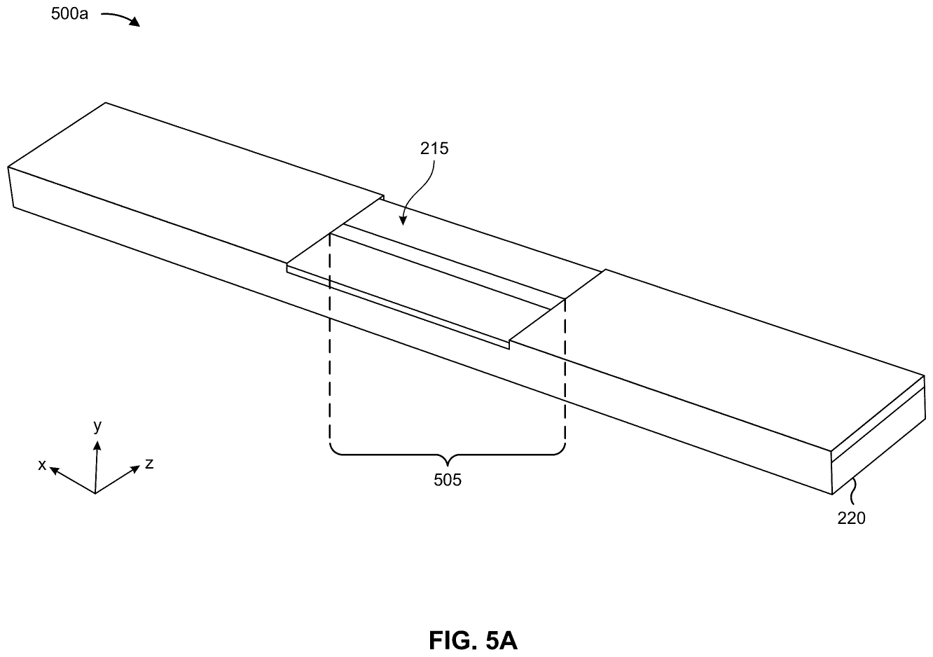

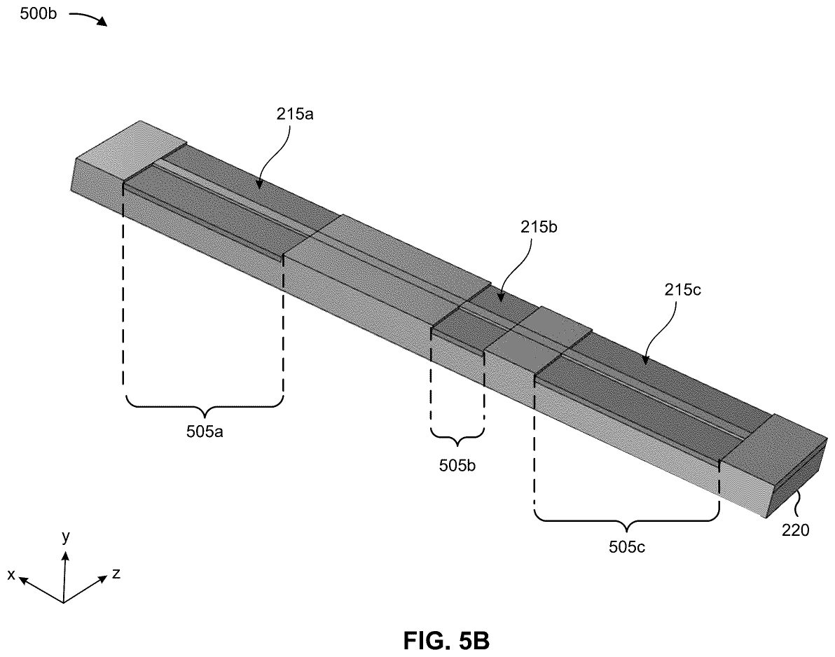

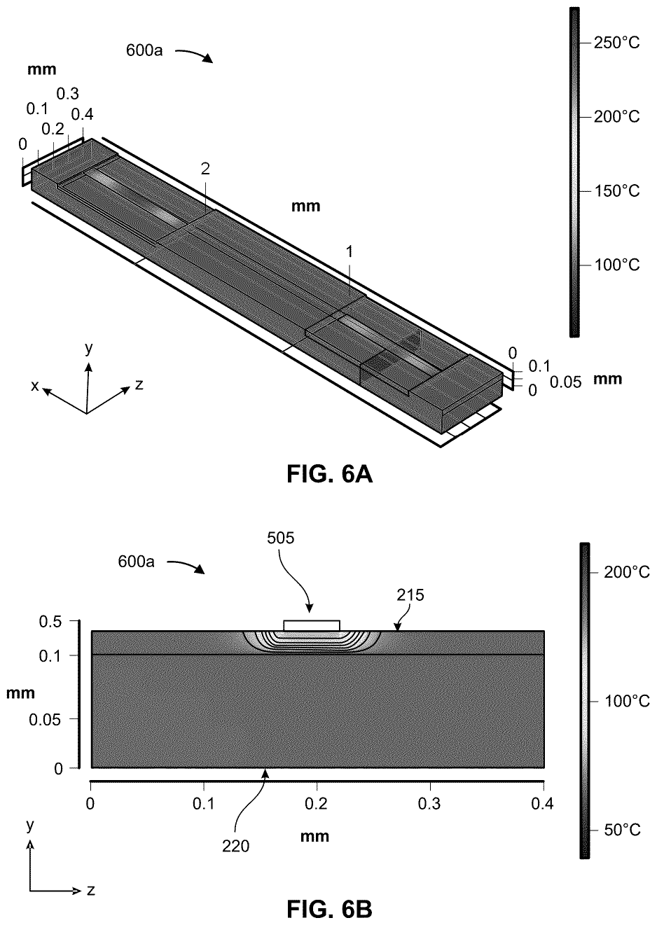

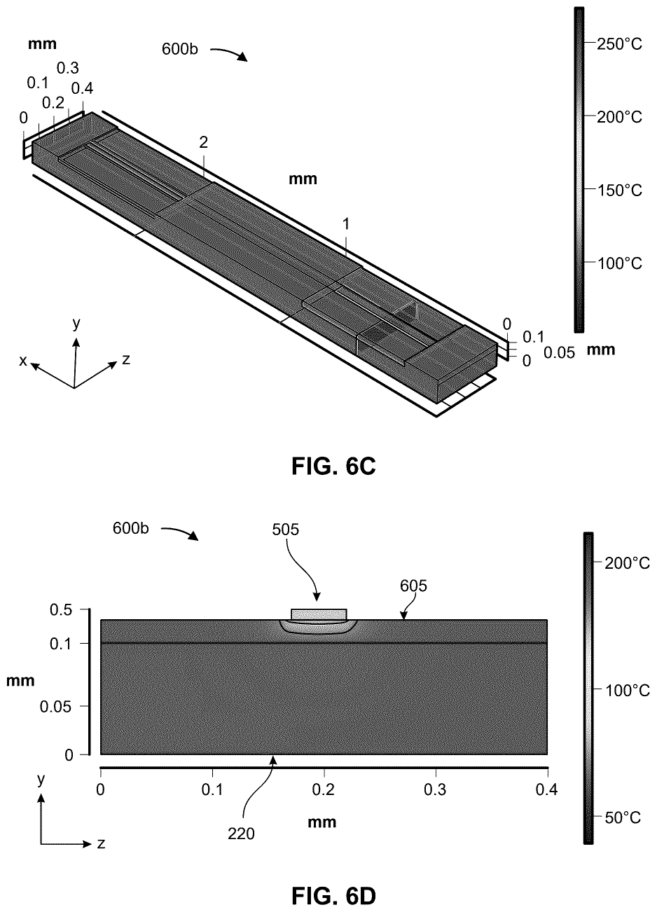

FIG. 6A is a 3D view of a thermal finite element analysis (FEA) simulation for a tunable photonic structure 600a that includes a thermal insultation material according to one or more implementations. FIG. 6B is a cross-section view of the thermal FEA simulation for the tunable photonic structure 600a shown in FIG. 6A according to one or more implementations. For example, the tunable photonic structure 600a includes the thermal insultation material 215 described in connection with FIGS. 2 through 5. Accordingly, thermal insultation material 215 (e.g., silica aerogel) that is in between multiple optical tuning sections 505 and the substrate 220.

As shown in FIGS. 6A and 6B, the multiple optical tuning sections 505 are at a temperature of approximately 225° C. Additionally, a first portion of the thermal insultation material 215 that is in contact with the optical tuning sections 505 is at a temperature of approximately 150° C. and a second portion of the thermal insultation material 215 that is in contact with the substrate is at a temperature of approximately 50° C. Therefore, the thermal insulation material 215 allows the substrate 220 to experience temperatures that satisfy a range of operating temperatures of the substrate 220.

As indicated above, FIGS. 6A and 6B are provided as examples. Other examples may differ from what is described with regard to FIGS. 6A and 6B.

FIG. 6C is a 3D view of a thermal FEA simulation for a tunable photonic structure 600b that does not include a thermal insultation material. FIG. 6D is a cross-section view of the thermal FEA simulation for the tunable photonic structure 600b shown in FIG. 6C. For example, the tunable photonic structure 600b does not include the thermal insultation material 215 described in connection with FIGS. 2 through 5. Rather, the tunable photonic structure 600b includes a non-porous material 605 (e.g., silica) that is in between multiple optical tuning sections 505 and the substrate.

As shown in FIGS. 6C and 6D, the multiple optical tuning sections 505 are at a temperature of approximately 75° C. Additionally, a first portion of the non-porous material 605 that is in contact with the optical tuning sections 505 is at a temperature of approximately 65° C. and a second portion of the non-porous material 605 that is in contact with the substrate 220 is at a temperature of approximately 50° C. Therefore, using the non-porous material 605 instead of the thermal insulation material 215 reduces the upper temperature range that can be applied to the optical tuning sections 505 while satisfying a range of operating temperatures of the substrate 220. In other words, the thermal insulation material 215 enables optical tuning sections 505 to operate at higher temperatures compared to the non-porous material 605.

As indicated above, FIGS. 6C and 6D are provided as examples. Other examples may differ from what is described with regard to FIGS. 6C and 6D.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be designed to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When a component or one or more components (e.g., a laser emitter or one or more laser emitters) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A photonic structure, comprising:
a substrate;
an optical waveguide;
a heating component attached to a region of the optical waveguide; and
a thermal insulation material positioned between the substrate and the region of the optical waveguide, wherein:
the heating component is configured to apply heat to the region of the optical waveguide, and
the thermal insulation material is configured to thermally insulate the substrate from the heat applied to the region of the optical waveguide.

2. The photonic structure of claim 1, wherein the thermal insulation material has a coefficient of thermal expansion (CTE) associated with a percentage change in CTE over an operating temperature range of the heating component, and wherein the percentage change satisfies a percentage change threshold.

3. The photonic structure of claim 1, wherein the thermal insulation material comprises a structure that includes voids comprising more than half of a volume of the thermal insulation material.

4. The photonic structure of claim 3, wherein the thermal insulation material is made from an aerogel material.

5. The photonic structure of claim 1, wherein:
the heating component is configured with an upper bound temperature output, and
the thermal insulation material has a thermal conductivity value and a thickness that cause the substrate to maintain a temperature that satisfies a temperature threshold while the heating component operates at the upper bound temperature output.

6. The photonic structure of claim 5, wherein the thermal conductivity value is less than or equal to 0.1 watts per meter-Kelvin and the thickness is between 1 micron and 40 microns, inclusive.

7. The photonic structure of claim 1, wherein the region of the optical waveguide attached to the heating component forms an optical tuning section of the optical waveguide.

8. The photonic structure of claim 1, further comprising:
an interface material, wherein the interface material comprises:
a first layer that is between the substrate and the thermal insulation material, wherein the first layer is associated with a first lattice matching with the substrate; and
a second layer that is between the optical waveguide and the thermal insulation material, wherein the second layer is associated with a second lattice matching with the optical waveguide.

9. The photonic structure of claim 1, wherein the heating component is a resistive heater.

10. The photonic structure of claim 1, wherein the heating component is positioned above the optical waveguide.

11. A photonic structure, comprising:
a substrate;
an optical waveguide;
a set of heating components respectively attached to a set of regions of the optical waveguide; and
at least one thermal insulation material layer positioned between the substrate and the set of regions of the optical waveguide, wherein:
the set of heating components are respectively configured to apply heat to the set of regions of the optical waveguide, and
at least one thermal insulation material layer is configured to thermally insulate the substrate from the heat applied to the set of regions of the optical waveguide.

12. The photonic structure of claim 11, wherein the at least one thermal insulation material layer comprises a set of thermal insulation material layers respectively placed between the set of regions and the substrate.

13. The photonic structure of claim 11, wherein the at least one thermal insulation material layer comprises a single thermal insulation material layer that spans a length of the substrate and is placed between the set of regions and the substrate.

14. The photonic structure of claim 11, wherein the at least one thermal insulation material layer has a coefficient of thermal expansion (CTE) associated with a percentage change in CTE over an operating temperature range of the set of heating components, and wherein the percentage change satisfies a percentage change threshold.

15. The photonic structure of claim 11, wherein the at least one thermal insulation material layer comprises a structure that includes voids comprising more than half of a volume of the thermal insulation material layer.

16. The photonic structure of claim 15, wherein the at least one thermal insulation material layer is made from an aerogel material.

17. The photonic structure of claim 11, wherein:
the set of heating components are configured with an upper bound temperature output, and
at least one thermal insulation material layer has a thermal conductivity value and a thickness that cause the substrate to maintain a temperature that satisfies a temperature threshold while one or more heating components from the set of heating components operate at the upper bound temperature output.

18. The photonic structure of claim 17, wherein the thermal conductivity value is less than or equal to 0.1 watts per meter-Kelvin and the thickness is between 1 micron and 40 microns, inclusive.

19. The photonic structure of claim 11, wherein the set of regions respectively attached to the set of heating components forms a set of tuning sections of the optical waveguide.

20. A photonic structure, comprising:
a substrate;
first and second support bars extending upwardly from the substrate;
an optical waveguide that is supported by the first and second support bars so that a first gap exists between the substrate and the optical waveguide;
a heating component attached to a region of the optical waveguide; and
a thermal insulation material that fills the first gap, wherein:
the heating component is configured to apply heat to the region of the optical waveguide, and
the thermal insulation material is configured to thermally insulate the substrate from the heat applied to the region of the optical waveguide.
